(19) United States
(12) Patent Application Publication
(10) Pub. No.: US 2005/0077012 A1
(43) Pub. Date: Apr. 14, 2005

(54) Installation for producing a spunbonded nonwoven web consolidated by fluid projection

(76) Inventor: Andre Vuillaume, Montbonnot (FR)

Correspondence Address: PEARNE & GORDON LLP, 1801 EAST 9TH STREET, SUITE 1200, CLEVELAND, OH, 44114-3108, US

(21) Appl. No.: 10/474,587

(22) PCT Filed: Apr. 9, 2002
(86) PCT No.: PCT/FR02/01228

(30) Foreign Application Priority Data
Apr. 13, 2001 (FR) 01/05103

(51) Int. Cl. B29B 7/00

(52) U.S. Cl. 156/441; 156/500

(57) ABSTRACT

The invention concerns an installation for producing spunbonded nonwoven web, comprising a die designed to set filaments in a web in a deposition point on an endless conveyor and means for consolidating the web in a consolidation point downstream of the deposition point, characterized in that the consolidation means consist of a device projecting a fluid jet on the web at the consolidation point.

The present invention relates to the installations for producing spunbonded nonwoven webs. These nonwoven webs are formed from continuous plastic filaments, most often with a mean diameter greater than 7 microns, in particular between approximately 8 and 30 microns. The filaments are formed by the melted plastic being extruded from a plurality of thin, usually circular capillary holes of a die, the diameter of the extruded filaments being rapidly reduced after cooling in what is often called an attenuator. The filaments drawn in this way are separated from one another as well as possible and fall onto a conveyor where they form the web.

The conveyor, permeable to air and to water, is a component element of the installation which is highly complicated. To be precise, it is found that it has to be changed well before it becomes warn, because some of its parts are clogged and then produce a nonwoven web which is not sufficiently uniform or of good quality.

The invention overcomes this disadvantage by means of an installation for producing a spunbonded nonwoven web, in which the conveyor has a longer useful life, which provides a nonwoven web of better quality and which is simpler and less costly than the installations known hitherto.

The subject of the invention is, therefore, an installation for producing a spunbonded nonwoven web, comprising a die arranged so as to deposit filaments in the form of a web onto an endless conveyor at a depositing point and means for consolidating the web at a consolidation point located downstream of the depositing point. According to the invention, the consolidation means consist of a device for projecting a fluid jet onto the web directly at the consolidation point. By “directly” is meant without a consolidation device of another type, in particular with rollers, being interposed between the device for projecting a fluid jet and the depositing point.

It has now been understood that the cloggings of the conveyor were attributable to the fact that, from time to time, a break of the filaments at the die outlet occurred, thus producing a plastic mouse comprising a melted plastic core coated with hardened plastic. When this core arrived under a pressure roller provided for consolidating the web, as described, for example, in WO 00/66821, the roller crushed the mouse and the melted plastic core penetrated into the meshes of the conveyor and adhered thereto, without it being possible subsequently to clean the conveyor. This gave rise, on the conveyor, to a definitive fault which generates a fault on the nonwoven web whenever this point on the conveyor receives the web. By a fluid jet, in particular a liquid jet, more simply a water jet, being projected onto the web at the consolidation point, on the one hand, the mouse is cooled and tends to a lesser extent to adhere and, on the other hand, it is not compressed to a point of causing it to burst and expel the melted mass of the core. Although the mouse is incorporated into the spunbonded nonwoven web which is passing, the fault is no longer reproduced during the subsequent passages over the conveyor.

The conveyor is usually a synthetic or metallic fabric, generally consisting of polyester or polyamide, sometimes of bronze or stainless steel. The air permeability of the conveyor is generally between 250 CFM and 800 CFM.

In order to hold the web from the depositing point to the consolidation point, a suction box was provided at this location under the conveyor. This box necessarily had large dimensions, because the diameter of a roller makes it an absolute requirement to move it away from the bottom of the assembly forming the die. Since a device for projecting a water jet may be much narrower than a roller, the depositing point and the consolidation point can be brought closer to one another in such a way that this long and bulky and therefore complicated box can now be dispensed with. Preferably, the depositing point, which is a line corresponding to the intersection of the plane of symmetry of the assembly forming the die and of the conveyor, and the consolidation point, which is also a line extending substantially over the entire width of the conveyor and which is defined by the point of impact of the jet on the conveyor, are at a distance from one another which is smaller than 1 m. The projection device may be a row of fluid orifices or a plurality of parallel rows of orifices, preferably two rows, each row being perpendicular to the direction of travel of the conveyor. When there is an odd number of rows, the consolidation point may be considered as the median line of the median row. When there is an even number of rows, the consolidation point passes through the middle of the gap between the central rows, for example between the second and the third row, if there are four of these. The orifices preferably have a diameter of 70 to 200 microns with a gap between the orifices of 0.4 mm to 5 mm.

Conventionally, a suction box is arranged below the depositing point, on the other side of the water-permeable conveyor in relation to the assembly forming the die. It is also preferable that the conveyor passes between the projection device and a suction box at the consolidation point, thus improving the hydrodynamic entanglement and therefore the consolidation of the web.

Good consolidation was obtained when the outlet orifices of the nozzles of the projection device are at a distance of 1 to 100 mm from the conveyor at the consolidation point, in particular at a distance of 5 to 30 mm. The projected water is usually under a pressure of between 5 bar and between 100 bar. The partial vacuum in the body underneath the consolidation point may be between 10 mbar and between 200 mbar.

Preferably, a web drying device, which is preferably above the conveyor, is provided downstream of the consolidation point, while a vacuum device, which likewise facilitates the dehydration of the web, is provided below and preferably upstream of the drying device.

The invention is also aimed at a spunbonded nonwoven web also intermingled hydrodynamically.

In the accompanying drawing, given purely by way of example,

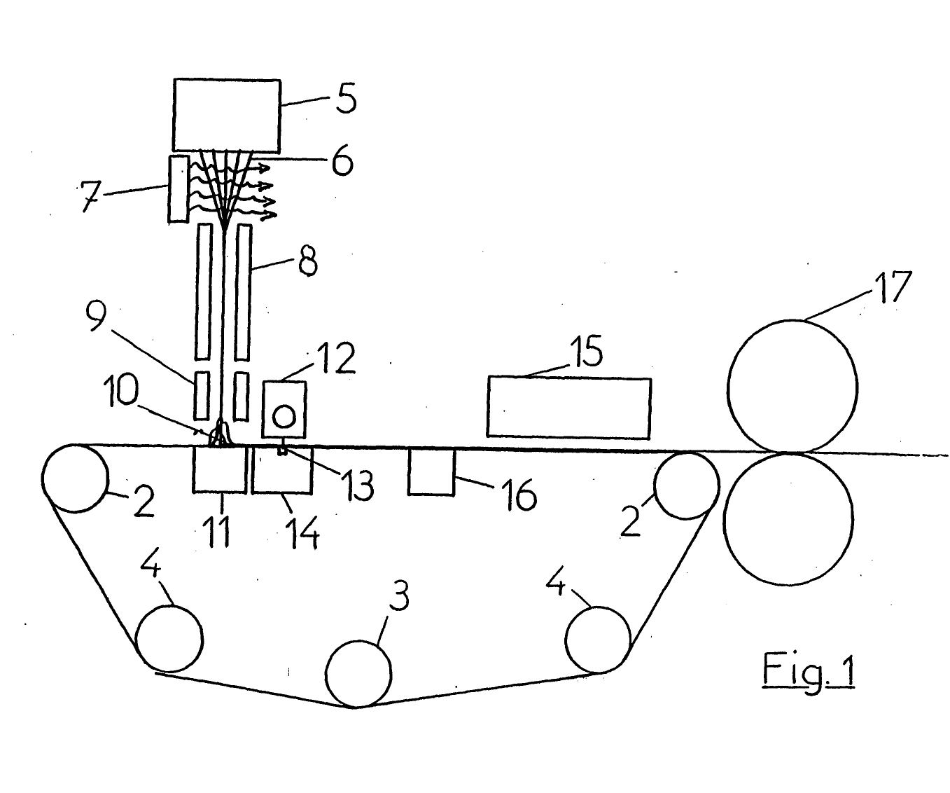

FIG. 1 is a diagrammatic sectional view of an installation according to the invention, while

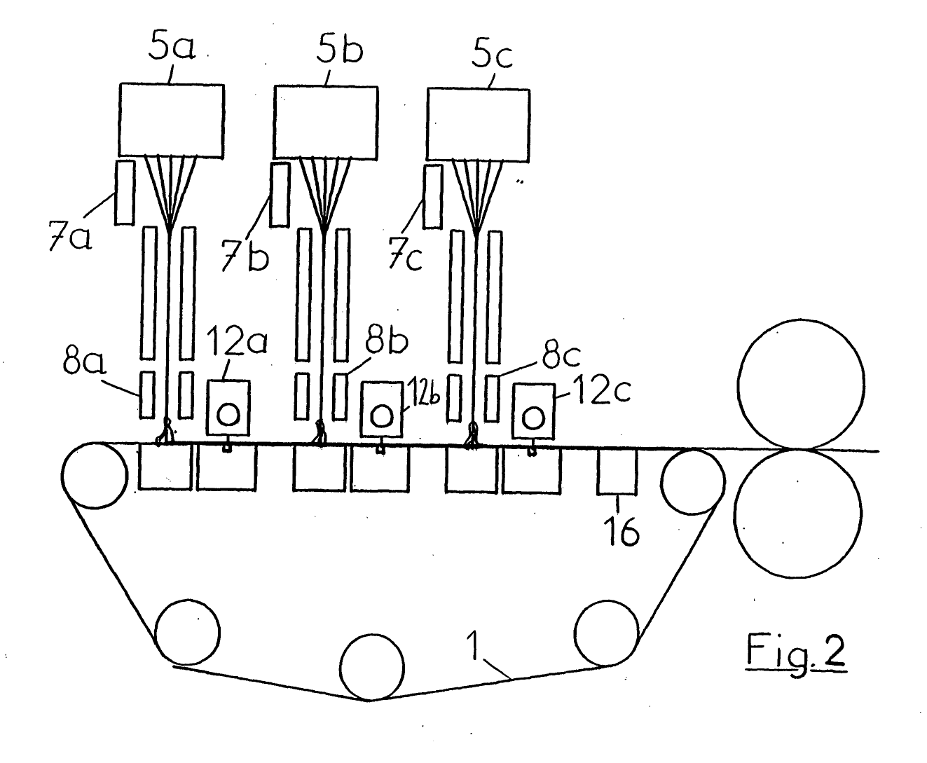

FIG. 2 illustrates a variant.

The installation according to the invention comprises a water-permeable mesh-type conveyor 1 which consists of a material resistant to corrosion and to rust, in particular of polyester, and which passes over guide rollers 2 and also over a drive roller 3 and tensioning rollers 4. The endless conveyor rotates, while having an upper horizontal strand which, in FIG. 1, goes from left to right. Above the conveyor is located an assembly of conventional dies, comprising an actual die 5, from which emerge spunbonded filaments 6 which are cooled by a cooling device 7, then drawn and reduced in diameter in an attenuator 8, before being opened in a formation device 9 and falling onto the conveyor 1 at a depositing point 10. A suction box 11 is provided, opposite the depositing point 10, below the horizontal strand of the conveyor 1.

At a distance of 200 mm from the depositing point 10, downstream of the latter, on the horizontal strand of the conveyor 1, a water jet projection device 12, consisting of two rows of projection orifices, is mounted above this strand. The water is projected onto the nonwoven web, carried by the horizontal strand of the conveyor 1, at a consolidation point 13. A suction box 14 is arranged opposite the water projection device 12 on the other side of the horizontal strand of the conveyor 1.

An infrared drying device 15 is provided, above the horizontal strand of the conveyor 1, downstream of the consolidation point 13, while a vacuum device 16 is provided, below the horizontal strand of the conveyor 1, upstream of this device 15. The consolidated spunbonded nonwoven web is detached from the conveyor 1 so as to pass into a calender 17.

In FIG. 2, three dies 5a to 9a, 5b to 9b and 5c to 9c, followed by their respective water projection device 12a, 12b and 12c, are mounted successively above the horizontal strand of the conveyor 1.

1-8. (canceled)

9. An installation for producing a spunbonded nonwoven web, comprising a die arranged to deposit filaments in the form of a web onto an endless conveyor at a depositing point and means for consolidating the web at a consolidation point downstream of the depositing point, said means consisting of a projection device for projecting a jet of fluid onto the web at the consolidation point, characterized in that the consolidation point is directly downstream of the depositing point, without a consolidation device of another type interposed between the projection device and the depositing point.

10. The installation of claim 9, wherein the distance between the depositing point and the consolidation point is less than 1 meter.

11. The installation of claim 10, wherein the projection device includes outlet orifices located at a distance of 1 to 100 mm from the conveyor at the consolidation point.

12. The installation of claim 11, wherein the outlet orifices are located at a distance of 5 to 30 mm from the conveyor at the consolidation point.

13. The installation of claim 9, wherein the conveyor passes between the projection device and a suction box at the consolidation point.

14. The installation of claim 9, further including a drying device for drying the nonwoven web, downstream of the consolidation point.

15. The installation of claim 14, further including a vacuum device upstream of the drying device.

16. The installation of claim 15, wherein the fluid is water.

17. A spunbonded nonwoven web produced in the installation of claim 9.
